(19) United States
(12) Patent Application Publication
(10) Pub. No.: US 2010/0213658 A1
(43) Pub. Date: Aug. 26, 2010

(54) TOOL UNIT, WORK TABLE

(75) Inventor: Werner HUBER, Nussdorf a. Inn (DE)

Correspondence Address: ZIEGLER IP LAW GROUP, LLC., 518 RIVERSIDE AVENUE, BUILDING B (Synergy), WESTPORT, CT, 06880, US

(73) Assignee: ESMO AG, Rosenheim (DE)

(21) Appl. No.: 12/705,578

(22) Filed: Feb. 13, 2010

(30) Foreign Application Priority Data
Feb. 17, 2009 (DE) 10 2009 009 267.6

(51) Int. Cl. B23Q 3/00

(52) U.S. Cl. 269/289 R

(57) ABSTRACT

A work-table for planar work pieces has a supporting plate for the work piece, which extends in two dimensions, a tool carrier for fixing at least one tool unit, the tool carrier being movable along the two dimensions of the supporting plate above the same, and a stand holding the supporting plate. The supporting plate has two or more sub-plates, at least one of which being foldable towards the other one.

### BACKGROUND

1. Field

The aspects of the disclosed embodiments relate to a tool unit and a work-table for planar workpieces.

Work-tables serve for machining planar work pieces. The work pieces can be wooden panels, press boards or MDF panels, plasterboard panels, stone slabs, metal sheets, composite panels, plastic panels or the like. The machining can be cutting, sampling, drilling, milling or the like. The machining can take place over the entire thickness of the board or only a partial area thereof.

2. Brief Description of Related Developments

Various disadvantages inhere in known work-tables:

Often it is desirable to place the work-table where the machined work pieces are assembled. For example, in the case of repairs of apartments, in the “drywall construction” often plasterboard panels are used. The dimensioning and machining of the panels takes place on site, so that the work-table must be on site as well. Up to now, however, transporting the work-tables has only been possible by laboriously disassembling and re-assembling them.

Furthermore, it is often difficult to obtain an exact knowledge about the exact machining point of the tool on the work piece. The digital path detection and display in x-direction and in y-direction are problematic insofar as a value is indicated which refers to an abstract coordinate system. An exact reference to the work piece, however, is often difficult to establish, e.g., when marks are applied to the work piece. Moreover, it is desirable to adjust tools in their working orientation. A saw, e.g., has a certain cutting direction. It is desirable to adapt the cutting direction to necessary cut orientations on the work piece. In this case it is sometimes difficult to establish the relationship to measured positions in x-direction and y-direction.

It would be advantageous to have a tool unit and a work-table which can easily be transported and easily handled during machining.

### SUMMARY

This object is achieved with the features of the independent claims. Dependent claims are directed on preferred embodiments.

FIG. 1 schematically shows a work-table. It comprises a supporting plate 5 extending in two dimensions (x, y) and a tool carrier 4 which is movable along the two dimensions of the supporting plate 5. At both sides of the supporting plate 5 parallel rails 2a, 2b can be provided, on which carriages 7a and 7b travel which are connected by a bridge 3. On the bridge 3 a tool carrier 4 can be shifted. The bridge 3 is shiftable by means of the carriages 7 on the rails 2 along one (x) of the dimensions of the supporting plate, the tool carrier 4 is shiftable along the bridge 3 and, thus, along the second spatial dimension (y). Thus, a tool unit fixed to the tool carrier 4 can be shifted into a desired position across the supporting plate 5. The tool unit can also be shifted into the vertical direction (z) relative to the tool carrier 4, so that, altogether, the tool can be lifted and lowered. The positions in the x-direction and in the y-direction can be measured and displayed digitally, so that information is present where the tool carrier or the tool is located relative to a coordinate system. The supporting plate 5 bears on a stand 6.

According to the aspects of the disclosed embodiments, a work-table for planar work pieces has a supporting plate for the work piece, which extends in two dimensions. The supporting plate consists of two or more sub-plates, at least one of them being foldable. Preferably two sub-plates are provided which, in a working position, are adjacent in a common plane and, in a transport position, extend approximately parallel in a spaced apart position.

By spacing the plates apart the carriages, the bridge and the tool carrier can remain mounted to one of the plates and do not have to be dismounted for the transport. The stand can have a cart provided with rollers, so that the work-table can be moved, particularly when it is in its upright folded state.

A tool unit which can be used at a work-table is characterized by a display means for displaying a positioning aid for the tool on the work piece. The display means can operate with light, preferably laser light, and can project line markings which are oriented towards a machining center of the tool of the tool unit. Two line markings which intersect in the machining center of the tool can be projected.

In this way lines become visible on the work piece which provide information on where the machining center of the tool is located. A user can orientate the lines, e.g., towards markings.

A tool unit which can be used together with a work-table has a tool for machining a work piece and a fastening unit for fixing the tool unit to a tool carrier of the work-table. The tool is rotatable relative to the fastening unit about a rotational axis perpendicularly to the plane of the work-table and lockable and releasable again within a defined rotational angle range at will. The rotation can be effected in such a way that the rotational axis extends through the machining center of the tool. In this way it is ensured that the digital measurement of the distance is largely invariant regarding rotations of the tool.

### BRIEF DESCRIPTION OF THE DRAWINGS

In the following, aspects of the disclosed embodiments are described with reference to the drawings.

FIG. 1 shows a work-table according to the aspects of the disclose embodiments,

FIG. 2 schematically shows a tool unit at a tool carrier with a display means,

FIG. 3 schematically shows a tool unit with a rotatable tool,

FIG. 4 schematically shows a work-table with plates and a stand, and

FIG. 5 shows a work-table in the transport position.

### DETAILED DESCRIPTION OF THE DISCLOSED EMBODIMENTS

Basically, same reference numerals in this description mean same features. Features are also combinable with each other even if this combination is not expressly mentioned, as far as the combination is not impossible for technical reasons.

In a preferred embodiment, the machining of plasterboard panels by sawing or milling is considered. However, the other above-mentioned applications are conceivable as well.

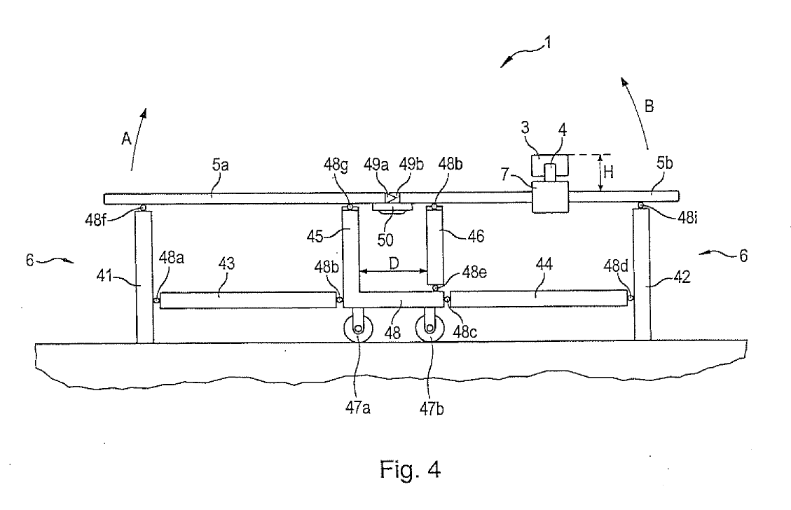

FIG. 4 schematically shows a work-table 1 comprising a stand 6, a supporting plate 5 and a tool carrier 4, which can shiftably be guided along the bridge 3 by means of carriages 7 on the rails 2 of the supporting plate 5. The supporting plate has two sub-plates 5a and 5b, at least one of which being pivotable.

In the shown embodiment, the stand 6 has a cart 48 which stands on several rollers or casters 47 which can be lockable. The cart shows two inner pillars 45 and 46, each one of which supports one of the sub-plates 5a and 5b. The inner pillars 45, 46 have a predetermined distance D to each other. Each of the sub-plates has, in its working position, starting from the supporting inner pillar 45, a certain projection extending towards the other sub-plate, so that the sub-plates meet between the two inner pillars, preferably in the middle.

The stand 6 further comprises a cantilever 41, 43, 42, 44. The cantilever 41, 43 has an outer pillar 41 which is connected via a strut 43 with the cart 48 and, in particular, with the associated inner pillar 45. The strut 43 extends preferably in parallel to the sub-plate 5a. The connection between the strut 43 and the pillars 41, 45 is rotationally movable; this connection is made by pivotal connecting joints 48a and 48b. Together, the inner pillar 45 and the outer pillar 41 bear the sub-plate 5a. The structure of the stand 6 below the sub-plate 5b can be mirror-inverted.

The connection of the sub-plates 5a, 5b with the respective pillars is rotationally movable as well, this connection is made by the pivotal connecting joints 48f, 48g, 48h and 48i. The rotational axes of the pivotal connecting joints are vertical to the plane of projection of FIG. 4.

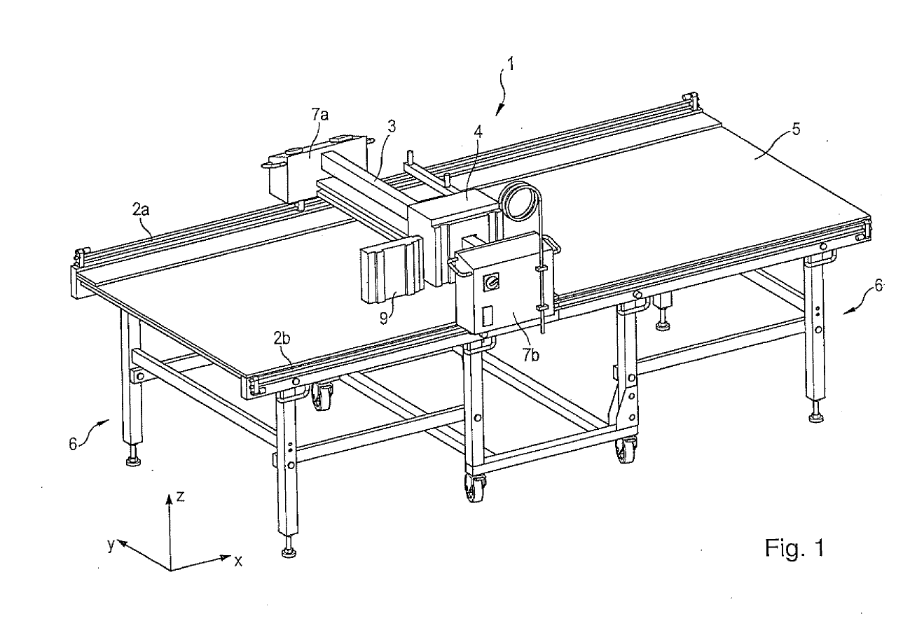

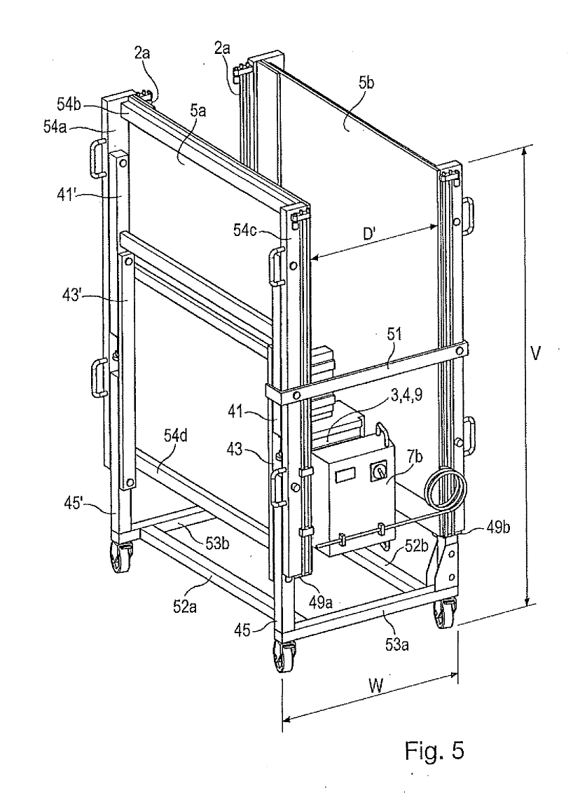

Reference is made to the fact that the pillars shown in FIG. 4 can be present twice in such a way that, outside the plane of projection (above or below), the same means are provided again for supporting the supporting plate 5 also along the dimension vertical to the plane of projection. These components lying outside the plane of projection can be designed in the same way and are not especially mentioned. In the perspective views of FIGS. 1 and 5 parts thereof can be seen, and some of them are provided with apostrophized reference numerals (e. g. 41′). On the other hand, the mentioned pillars can also have considerable dimensions in the direction perpendicular to the plane of projection.

Preferably, two sub-plates 5a and 5b are provided which are respectively rotatable about their joints 48g, 48h at the inner pillar 45, 46 about a rotational axis perpendicular to the plane of projection of FIG. 4. In particular, they are foldable upwards along the direction of the arrows A and B. In the shown state of FIG. 4 they take up a working position (horizontal orientation), whereas FIG. 5 shows the upright folded state (approximately vertical orientation). This state is called the transport position. In the upright folded state (transport state) the two sub-plates 5a and 5b can be approximately parallel to each other and perpendicular (angle relative to each other <10°). The above-mentioned projections respectively lie at the inner side of the respective inner pillar.

The surfaces of the sub-plates 5a and 5b are spaced apart from each other by a distance D′ at least in an area along the height. The distance D′ is of a size that in the resulting free space the assembly of tool carrier 4 and bridge 3 can be accommodated. The distance D′ is selected in such a way that it is larger than the largest height H of the tool carrier above the supporting plate 5. This has the effect that, when the plates are folded upwards into the transport state, the bridge 3 and the tool carrier 4 need not be removed, but can remain mounted and must only be locked.

The inner width (overall dimension) of the work-table in transport position is preferably <80 cm. The distance D′ between the upright plates 5a and 5b is preferably >30 cm or >40 cm. Due to the mentioned dimensions it is ensured that, on the one hand, the tool carrier 4 with the bridge 3 is accommodated in the resulting free space, and that, on the other hand, the work-table in the upright folded position (transport position) can still be rolled through comparatively narrow doors. Altogether, there holds H<D′<D<W. The vertical extension V of the work-table in the transport position can be smaller than 1.90 m, so that the work-table in transport position can also be rolled through comparatively low-built doors.

In working position (sub-plates 5a and 5b folded down as shown in FIG. 4) the pillars 41, 45, 46 and 42 are preferably parallel to each other. When the plates are folded upwards, the outer pillars 41 and 42 come to lie in parallel to the respective supporting plate. The cart 48 shows a cross-strut 53a which connects the two inner pillars 45 and 46 with each other. The cross-strut 53a can lie comparatively low and, in particular, comparatively slightly above the rollers or casters 47.

The cart can also comprise a fixedly mounted or detachable box which, e.g., can be borne on the horizontally extending struts 52 and 53 of the cart 48. It can contain accessories (e.g., tool units 20, cables, consumables, spare parts, . . . ). There can be provided several of these boxes, one behind the other, in particular in a direction perpendicular to the plane of projection of FIG. 4.

The sub-plates 5a and 5b can respectively have a more or less rigid frame 54. In particular lateral flanks 54a and 54c can be provided at which the pillars 41, 45, 46, 42 can be mounted so as to be rotatable. The flanks 54a and 54b can be provided in structural unity with the guide rails 2 for the carriages 7.

A clamping device 50 can be functionally provided between the two sup-plates 5a and 5b, by means of which, in the working position, the work-plates are drawn towards each other and held in this state. This can be effected by a lever closure. Moreover, between the sub-plates 5a and 5b an alignment aid 49a, 49b can be provided, which is preferably self-centering, and which effects the exact positioning of the sub-plates 5a and 5b relative to each other in the working position. This aid can be complementary members, e.g., on the side of the one plate a circular-cylindrical cone 49a, and on the side of the other plate a complementary recess 49b, which are drawn towards each other and into each other by the clamping device 50. In order to allow, for this purpose, a certain movement of one sub-plate in horizontal direction (FIG. 4), one of the inner pillars 46 can be mounted to the cart 48 so as to allow rotational movements. For this purpose a pivotal connecting joint 48e is provided.

Reference numeral 51 designates a transportation lock, by means of which the sub-plates 5a and 5b in their un-folded state are held in a defined position relative to each other. The outer pillars 41 and 42 can be embodied with or without rollers at their lower ends. The transportation lock 51 can also be designed in the form of a container which can be suspended at the upper edges of the two sub-plates 5a and 5b and positioned between the two sub-plates 5a and 5b, which can take up materials.

The pivotal connections 48f-i between pillars and sub-plates (or flanks of the same) can be adapted so that they can be established and released without the use of tools. The pivotal connecting joints can be quick connectors. In this way it is ensured that the plates can be quickly removed if an opening turns out to be too small for the work-table in its transport position being brought into the respective room.

In FIG. 1 reference numeral 5′ designates a work piece surface and reference numeral 4 the tool carrier to which a tool unit 20 according to the aspects of the disclosed embodiments can be fixed. The connection can be detachable. It can be designed in such a way that, together with establishing a mechanical connection, also the electrical contacts (energy, signals) are established. A display means 21 is provided by means of which the positioning aids for the tool are displayed on the work piece. The display means can comprise several units 21a, 21b, 21c. These units can comprise light sources, preferably laser light sources which project a line marking.

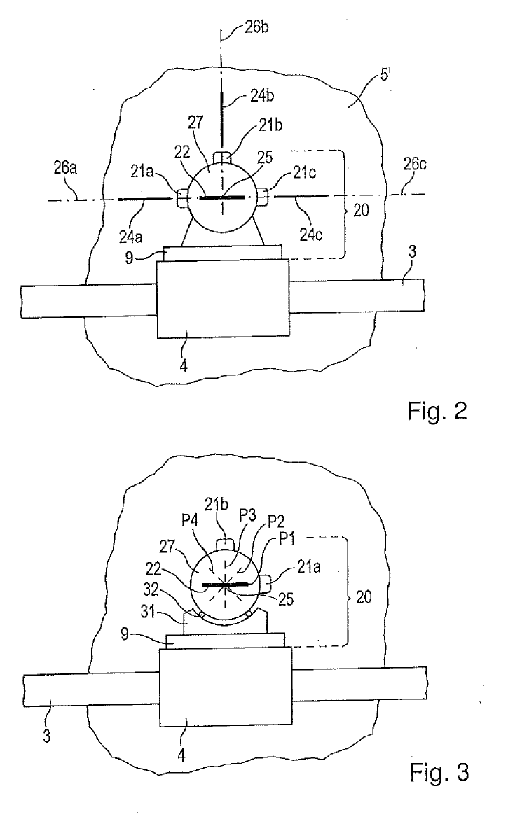

In FIG. 2 the projected line markings are shown by the bars 24a, 24b and 24c. These are markings projected onto the work piece. Here, the markings are bars of light on the work piece surface 5′. The light can be conventional light or laser light. The markings can lie on straights which extend at right angles to each other. They can be oriented towards a preferred coordinate system of the work-table (e.g., the x-and y-coordinates thereof).

The markings can be straight lines which are luminously projected onto the work piece. They lie on straights 26 and, if there are provided a plurality of markings and, accordingly, a plurality of straights on which the plurality of markings lie, they can intersect these straights. The intersection of these straights 26 can lie in the machining center 25 of the tool. The machining center can, e.g., be the rotation center of a milling cutter or the rotation center of a drill or the lowest point of a sawing blade of a buzz saw or the starting point of the blade of a jigsaw. In this way it is ensured that the markings precisely indicate the machining center of the respective tool.

In FIG. 2 reference numeral 22 schematically shows the position of a sawing blade of a buzz saw. The dashed lines 26a, b, c indicate the straights on which the line markings 24a, b, c lie. The intersection 25 lies at the machining center of the tool 22, i.e., for example at the lowermost point of a buzz saw blade. When the tool 22 is pivotable (e.g. about the vertical axis, vertically to the plane of projection of FIG. 2) the display means 21 can be pivotable together therewith. They can be mounted to the tool unit 20. They can, however, also remain fixed. They can also be pivotable separate from the tool, in this case possibly in such a way that the position of the intersection 25 does not change relative to the machining center of the tool. The display means 21 can, however, also be mounted to the tool carrier 4.

The display means 21 can be designed so that the markings 24 extend along an adjustable path. The markings 24 can be comparatively short markings and even only dot markings. The markings, however, can also be bars having a length of some centimeters. Seen from above they extend outside of the contour of the tool, preferably away from the tool and can possibly extend up to the edge of the bench 5.

FIG. 3 shows a tool unit 20 with a tool 27 and a fastening unit 31, 32, 9, by means of which the tool unit can be fixed to the tool carrier 4 which is movable in one plane. The tool 27 is rotationally supported relative to the fastening unit 31, 9 and can be moved into any angle of rotation and locked in this position. The rotary axis is perpendicular to the plane of projection of FIG. 3 or perpendicular to the supporting plate 5 of FIG. 1.

The rotary axis can extend through the machining center 25 of the tool 27. The bars P1, P2, P3 and P4 designate possible rotary positions of the tool, e.g. the possible longitudinal orientations of a sawing blade of a buzz saw. Reference numeral 25 designates the machining center of the tool, e.g., the lowermost point of the buzz saw blade.

The rotationally movable as well as lockable and releasable fixing of the tool relative to the fastening unit can be effected by a suitable leverage or a pivot bearing 32.

The angular range within which a rotation is possible can be 95° or more or less or it can also be 185° or more or less.

Due to the general rotatability it is ensured that also diagonal cuts can be made. The mode of working can be such that the tool is guided along a template or is guided by the longitudinal direction (saw blade orientation) given by the tool. Then, e.g., the bridge 3 can be shifted, while the tool carrier 4 freely slides along the bridge 3, so that automatically the respective movement ensues.

Generally, a tool unit 20 can have one or more downwardly protruding guiding pins which have a defined position relative to the tool and which are adapted to engage into a template or to be moved along the template. The template can be placed on the work piece.

A tool carrier 4 can have plural mounting ports of preferably same construction for a plurality of tool units 20. Each one can serve for the mechanical hold and the supply with energy and signals for a tool unit 20. The fastening positions can lie on different sides of the bridge 3, if the tool carrier 4 surrounds the bridge at both sides. The functional orientations of the plural fastening positions can be parallel to each other or at a possibly adjustable angle relative to each other, e.g. at 90°, in the plane of projection of FIG. 3.

FIG. 5 shows that, when the sub-plates 5a and 5b are folded up, the sub-plates take the outer pillars 41, 42 mounted to them along upwards, so that they are lifted from the ground. In side view, the sub-plates 5a, 5b together with the respective strut 43, 44 and the associated pillars preferably form a parallelogram, so that, when the plates are folded, the pillars remain in parallel to each other, as in the initial state. Then, in the transport position, all components of the work-table are borne by the cart 48 and, in this way, can be moved. In the transport position, the sub-plate can extend perpendicularly and in parallel to the pillars.

The features shown in FIGS. 2, 3, 4 and 5 can be combined with each other.

What is claimed is:

1. A work-table for planar work pieces, comprising:
a supporting plate for the work piece extending in two dimensions,
a tool carrier for fixing at least one tool unit, the tool carrier being movable above the supporting plate along said two dimensions, and
a stand holding the supporting plate,
wherein the supporting plates comprise two or more sub-plates, at least one of which being foldable towards another one.

2. The work-table according to claim 1, further comprising two sub-plates which are both foldable between a working position and a transport position, in the working position the sub-plates being adjacent in a common plane, and in the transport position the sub-plates extending approximately parallel in a spaced-apart position, with the distance (D′) being such that in the obtained free space the tool carrier is accommodated.

3. The work-table according to claim 2, wherein the stand comprises a cart with two inner pillars and two cantilevers with one outer pillar, respectively, each sub-plate having a pivotal connection at one inner and one outer pillar, and the cart being on rollers.

4. The work-table according to claim 3, wherein the connection can be established or released without tools.

5. The work-table according to claim 3, wherein the distance (D) between the inner pillars is larger than the distance (D′) between the sub-plates in their upright folded state.

6. The work-table according to claim 2, further comprising a clamping device and self-centering alignment aids at the sub-plates, which, in the working position, align the two sub-plates towards each other.

7. The work-table according to claim 6, wherein one of the inner pillars is pivotable relative to the cart.

8. A tool unit with a tool for machining a work piece, comprising:
a display means for displaying a positioning aid for the tool on the work piece.

9. The tool unit according to claim 8, wherein the display means projects at least one line marking by means of light, which lies on a straight extending through a machining center of the tool on the work piece.

10. The tool unit according to claim 9, wherein the display means projects two line markings which lie on straights which intersect in the machining center of the tool on the work piece.

11. The tool unit according to claim 8, wherein the display means comprises one or more laser light sources.

12. A tool unit comprising:
a tool for machining a work piece, and
a fastening unit by means of which the tool unit can be fixed to a tool carrier being movable in a plane,
wherein the tool is rotatable relative to the fastening unit about a rotational axis perpendicularly to the plane and is releasable and lockable within a defined rotational angle range at will.

13. The tool unit according to claim 12, wherein the rotational axis extends through a machining center of the tool.

14. A work-table for planar work pieces, comprising:
a supporting plate for a work piece, which extends in two dimensions,
a tool carrier for fixing at least one tool unit, the tool carrier being movable along the two dimensions of the supporting plate above the same, and
at least one tool unit fixed at the tool carrier, with a tool for machining the work piece,
wherein the tool unit is designed according to claim 8.

15. The work-table according to claim 14, wherein the display means is mounted to the tool carrier instead of to the tool unit.
